(19) United States
(12) Patent Application Publication
(10) Pub. No.: US 2008/0289839 A1
(43) Pub. Date: Nov. 27, 2008

(54) Method of controlling a screwdriving power tool

(75) Inventors: Peter Hricko, Buchs (CH); Alexander John, Rankweil (AT); Hans Boeni, Werdenberg (CH); Peer Schmidt, Lindau (DE); Jochen Kuntner, Dornbirn (AT)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/154,042

(22) Filed: May 19, 2008

(30) Foreign Application Priority Data
May 21, 2007 (DE) 10 2007 000 281.7

(51) Int. Cl. B25B 21/00; B23Q 5/00

(52) U.S. Cl. 173/1; 173/4; 173/176

(57) ABSTRACT

In a method for controlling a drive (4) of an electrically operated screwdriving power tool (2) during a screwdriving process, a tool holder (14) with a screw bit (16) fastened thereto is acted upon by the drive (4) to drive a fastening element (18) having a contact area (24) into a constructional component (20), with the screw bit movable up to a maximum screw-in value (Dmax) at a speed (D) and a operational torque (MA) generated between the screw bit (16) and the fastening element (18), and after it has been detected that a predetermined triggering screw-in depth (s0) has been reached, the speed (D) is reduced from the maximum screw-in value (Dmax) during a tightening process (AV), and, when it has been detected that a determined end value of the operational torque (MA) is reached, the screwdriving process is terminated.

### BACKGROUND OF THE INVENTION

1. Field of the Invention

The invention relates to a method of controlling a screwdriving process carried out with a line voltage-operated or battery-operated screwdriving power tool, particularly a hand-held screwdriving power tool, and to a hand-operated screwdriving power tool with a control device for carrying out the method. During a screw-in process, a tool holder with a screw bit fastened therein is acted upon by the drive in order to screw a fastening element having a contact area into a constructional component. The screw bit is moved at a maximum screw-in speed and generates an operational torque with respect to the fastening element. When it is detected that a predetermined triggering screw-in depth is reached shortly before the contact area of the fastening element contacts the constructional component, the speed is reduced from the maximum screw-in value in the course of a tightening process. When it has been detected that a determined end value of the operational torque is reached, the screwdriving process is terminated.

2. Description of the Prior Art

Screwdriving power tools of the type mentioned above with a torque-dependent control of the drive considerably facilitate driving-in of fastening elements compared to screwdriving power tools with a mechanically operating cut-off because the user has to carry out fewer pre-adjustments on the screwdriving power tool. At the same time, the risk of faulty settings or poorly executed settings is appreciably reduced, the working speed is increased, and the weight and dimensions of the screwdriving power tool are reduced.

A stationary screwdriving power tool for screwdriving and tightening screws and nuts with a true regulating procedure is known from German Publication DE 36 20 137 A1. This screwdriving tool carries out a screwdriving process in two process stages, namely, an application stage and a tightening stage, that are separated by a pause. Each of these process stages is terminated automatically when a predetermined shutdown screwdriving torque is reached. In so doing, through control by an inductive depth sensor, a screwdriving speed is reduced to an end value when approaching a contact state in which the screw or nut comes into contact with a substrate.

Through this known procedure, it can be ensured that a determined maximum tightening torque is maintained in screw connections so that cold welding between the fastening element and a constructional component is prevented.

The known method is disadvantageous in that it is only suitable for applications which stay the same, particularly because of the depth sensor that is provided and because of the necessity of predetermined shut-off screwdriving torques. On the other hand, the method is not suitable for applications in which several screwdriving processes follow one another directly at diverging angles between a work axis and a surface of the constructional component or in which the material characteristics of the respective constructional component are different. Consequently, the known method is not suitable for use in hand-held screwdriving power tools. In particular, it is not suitable for thread-forming applications in which the fastening elements are not screwed into previously prepared holders but in which, rather, the holders are only formed when the fastening elements are screwed into the respective constructional component by cutting or displacement.

### SUMMARY OF THE INVENTION

Accordingly, it is the object of the present invention to provide a method of the type mentioned above for controlling a drive of an electrically operated screwdriving power tool which overcomes the disadvantages mentioned above, and which ensures that a stable screw connection is produced in hand-guided screwdriving processes, particularly thread-forming screwdriving processes, regardless of the material characteristics of a constructional component on which the screwdriving process is carried out.

According to the invention, this and other objects of the present invention, which will become apparent hereinafter, are achieved by a control method in which a maximum tightening value of the operational torque at which the screwdriving process is terminated is determined after the predetermined triggering screw-in depth has been reached, depending on a curve of the operational torque until a reference point is reached. In this way, the curve of the operational torque during the screw-in process, in which the material of the respective constructional component is cut or deformed, can be used to assess its material characteristics. Based on this assessment, a maximum tightening value of the operational torque which is considered as particularly suitable for the respective constructional component can then be determined, and the screwdriving process is automatically terminated when this maximum tightening value is reached.

In a particularly preferred procedure, the maximum tightening value is calculated depending on a maximum screw-in value of the operational torque, which enables a reliable and simple assessment of the material characteristics of the respective constructional component.

The reference point is advantageously defined by the point in time at which the triggering screw-in depth is reached, plus a predetermined time period. In this way, it is possible to provide the triggering screw-in depth at a sufficient distance from the actual contact of the contact region of the fastening element, but at the same time, to provide the reference point in the immediate area of actual contact so that a greater deviation of the reference point from the actual contact of the contact area due to time delays can be prevented when determining the reference point.

The reduction in speed can preferably be carried out after the reference point is reached. The reduction has a continuous curve. Accordingly, the speed is progressively reduced directly at the start of the tightening process so that the tightening process can be terminated in a particularly exact manner with respect to the maximum tightening value of the operational torque.

A contact sensor advantageously detects when the triggering screw-in depth is reached so that it is possible to use a relatively robust sensor device that is not sensitive to soiling, moisture and vibrations that can occur particularly on construction sites.

Further, the speed is advantageously reduced to a predetermined intermediate value in the course of the tightening process. In this connection, it is possible to define the intermediate value in such a way that the tightening process is carried out sufficiently quickly, on the one hand, but a fast and exact termination is still ensured when the maximum tightening value of the operational torque is reached.

The operation of the drive is preferably terminated when the drive is switched off, and the time for switching off is selected in such a way that the desired maximum tightening value MAmaxA is reached when the motor comes to a stop. In this way, particularly with a curve of the operational torque that is uniform and not too steep during the tightening process, the screwdriving process can be terminated in a particularly exact and energy-efficient manner when the maximum tightening value is reached.

The operation of the drive is advantageously terminated by braking the drive. An active braking of the drive of this kind can be carried out, for example, by reversing the rotating direction of the motor, which can be realized in a particularly simple manner in electrically commutated motors by using the existing control electronics. The difference between the end value and the maximum tightening value with respect to time and quantity can be substantially reduced in this way so that the screwdriving process can be terminated in a particularly exact manner when the maximum tightening value is reached, particularly with a steep or irregular curve of the operational torque during the tightening process. The active braking can be provided as an alternative to or in addition to the passive braking. When used additionally, it may be decided, depending on the curve of the operational torque during the tightening process, whether the drive is braked passively or actively.

Further, the above-stated object is met by a hand-held screwdriving power tool with a control device for carrying out the method of one of the above-mentioned embodiments.

It is advantageous when the contact sensor has a contact sleeve which encloses the tool holder and which projects out over the contact area of a fastening element in an initial position of the screw holder in a screw-in direction. In this way, a reliable detection of the triggering screw-in depth can also be ensured when the fastening element is slightly inclined relative to the construction element to be machined. The triggering screw-in depth does not depend on the respective length of the fastening element in a detection of this kind.

A sensor device is advantageously provided for determining the driving torque. This sensor device detects the torque-dependent changes in a magnetic field defined by a magnetic area of a driveshaft, and these changes are communicated to the control device. This makes it possible to determine the driving torque in a particularly exact manner, and the sensor device is relatively compact and, therefore, requires a relatively small installation space itself within the screwdriving power tool.

In an alternative embodiment, sensor means which is connected to the control device are provided for determining a motor current occurring at the drive, a motor speed, and a change in the motor speed. The operational torque can accordingly be calculated from a driving torque that is determined as a function of a measured drive current, a resistance torque defined as a function of a measured speed, and a moment of inertia defined as a function of a determined change in speed. In this way, all of the sensors required for determining the operational torque can be arranged at the drive, which makes possible a particularly compact construction.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a side partially cross-sectional view of a screwdriving power tool according to the present invention;

FIG. 2A an elevational view of a front end of the screwdriving power tool according to FIG. 1 at the start of a screw-in process;

FIG. 2B an elevational view of the front end of the screwdriving power tool according to FIG. 2A when a predetermined triggering screw-in depth is reached;

FIG. 2C an elevational view of the front end of the screwdriving power tool according to FIG. 2B at the conclusion of a tightening process; and

FIG. 3 curves illustrating speed, operational torque, and displacement path of a contact sensor of the screwdriving power tool according to FIG. 1 during an exemplary screwdriving process.

### DETAILED DESCRIPTION OF THE PREFERRED EMBODIMENT

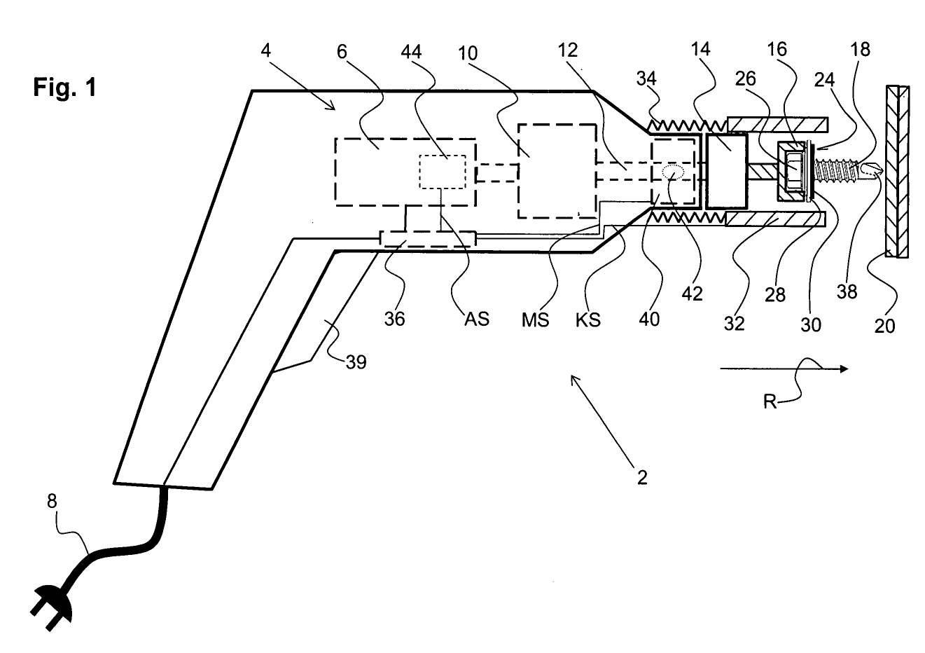

FIG. 1 shows an electrically operated screwdriving power tool 2 in the form of a hand-held drywall screwdriving power tool. This screwdriving power tool 2 has a drive 4 with a motor 6, e.g., a brushless motor, which, as is shown, is supplied with power by a line voltage cable 8 or, alternatively, a battery pack, and a gear unit 10.

A drive shaft 12 which is connected to a working tool holder 14 in the form of a bit holder is driven by the drive 4. A screw bit 16 is inserted into this tool holder 14, and a fastening element 18 such as, e.g., a self-tapping screw, can be screwed into a constructional component 20 along a screw-in direction R by means of the screw bit 16. The constructional component 20 can be formed of one part or, as is shown, of multiple parts, e.g., in the form of a sheet to be fastened to a support member.

The fastening element 18 has a contact area 24 which is formed in the shown embodiment by a side of a flexible ring 30 facing in the screw-in direction. The flexible ring 30 is provided at a washer 28 arranged at a screw head 26. Alternatively, the contact area 24 can also be formed by the washer 28 or by the screw head 26 itself. When a washer 28 is used, it can be integrated in the screw or formed separately.

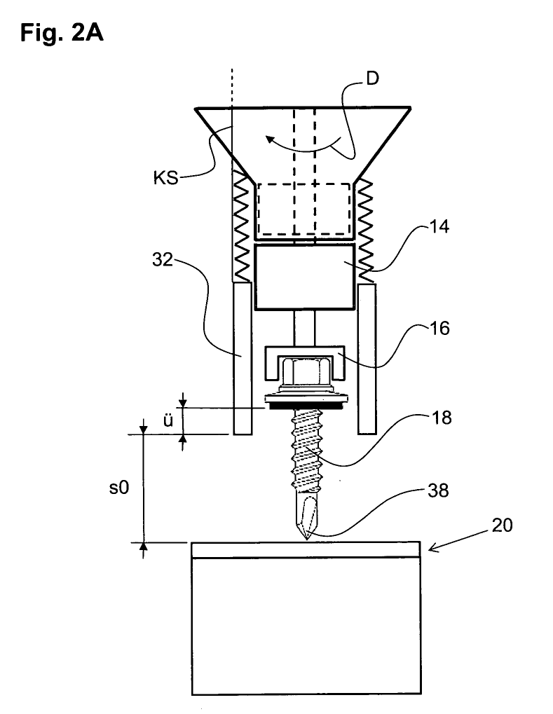

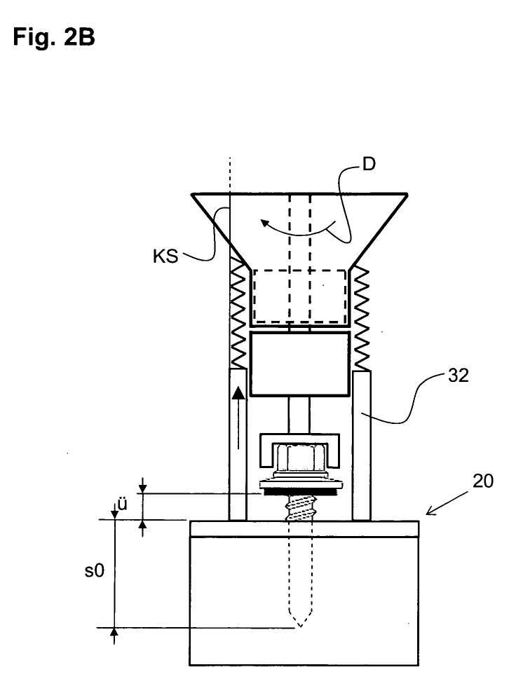

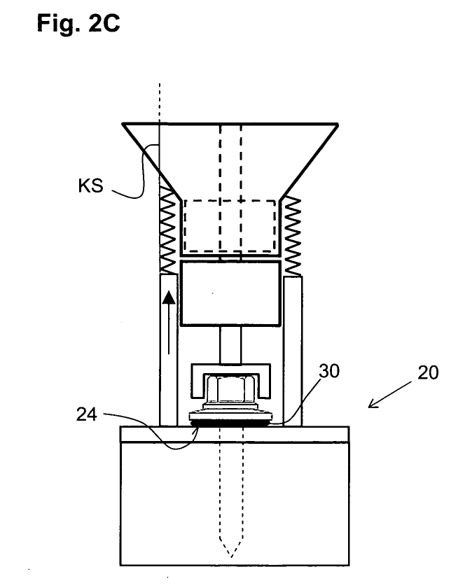

A sleeve-shaped contact sensor 32, which is biased by spring means 34 in a position in which it projects out over the contact area 24 in the screw-in direction R by an extension ü, is provided around the working tool holder 14 as can be seen particularly from FIG. 2a. In this way, a triggering screw-in depth s0 is determined by the contact sensor 32, and a corresponding signal is sent to a control device 36 via a contact sensor connection KS when this triggering screw-in depth s0 is reached. The drive 4 is controlled by means of this signal during a screw-in process EV.

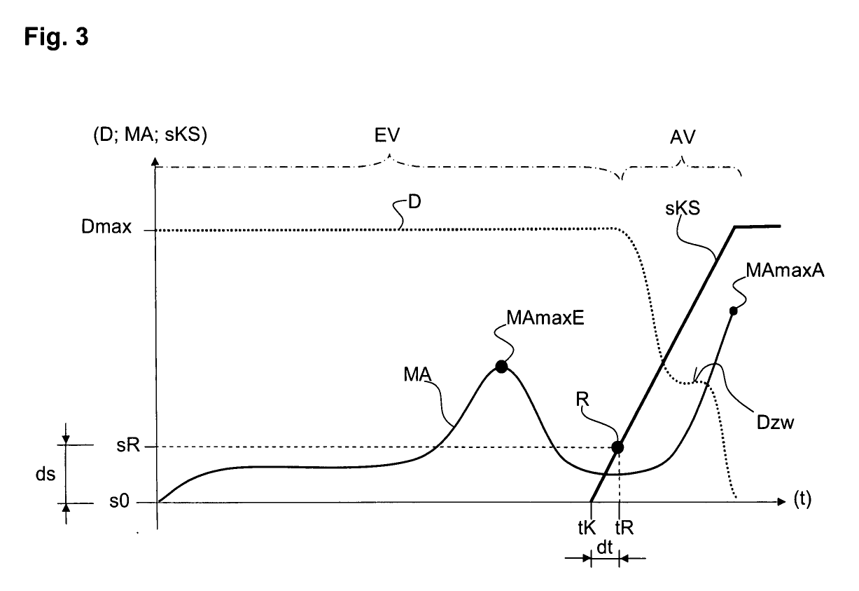

The curve of a screw-in process EV, which is controlled in the manner described above, is shown by way of example in FIGS. 2a, 2b, 2c and 3.

In a first step, as is shown in FIG. 2a, a tip 38 of the fastening element 18 is placed against the constructional component 20 and the drive 4 is set in operation by pressing an actuating element 39 (see FIG. 1). This starts the screw-in process EV in which the tool holder 14 and, with it, the screw bit 16 and fastening element 18 are driven at a rotational speed D.

FIG. 3 shows this screw-in process EV after a time point at which the speed D has already reached a maximum screw-in value Dmax. The fastening element 18 is now screwed into the constructional component 20 at this screw-in value Dmax of speed D. In so doing, the screwdriving power tool 2 exerts a varying operational torque MA on the fastening element 18, and the operational torque MA usually adopts an intermediate maximum screw-in value MAmaxE during the screw-in process EV, from which it drops again toward the end of the screw-in process EV.

As soon as the triggering screw-in depth s0 is reached at a contact time tK, the contact sensor 32 comes into contact with the first constructional component 20, as is shown in FIG. 2b, and sends a corresponding signal to the control device 36 via the contact sensor connection KS. After this contact time tK, the contact sensor 32 is displaced relative to the rest of the screwdriving power tool 2 in the ongoing screw-in process as is indicated by sKS in FIG. 3.

A reference point R is determined by means of the triggering screw-in depth s0 detected in this way. This reference point R can be defined, for example, by the contact time point tK itself or, according to FIG. 3, by a reference depth sR resulting from a predetermined displacement path ds of the contact sensor 32 or by a reference time point tR resulting from the contact time point tK, plus a predetermined time period dt.

In every case, the reference point R is selected in such a way that it coincides as closely as possible with the actual contact of the contact area 24 against the constructional component 20, after which the screw-in process EV is terminated and a tightening process AV has begun. During this tightening process AV, the operational torque MA increases again appreciably.

Depending on the curve of the operational torque MA until reference time point tR, the control device 36 now calculates a maximum tightening value MAmaxA of the operational torque MA at which the screwdriving process is to be terminated in its entirety. The calculation can be carried out, for example, depending on the maximum screw-in value MAmaxE occurring until the reference point R. Alternatively, any other detected curve characteristic of the operational torque up to reference point R, which could be suitable for assessing the material characteristics of the constructional component 20, can also be used for defining the necessary maximum tightening value MAmaxA. At the same time, the speed D is reduced by the control device 36 relative to the maximum screw-in value Dmax until the intermediate value Dzw by which the tightening process AV is initially advanced.

As can further be seen in FIG. 1, the control device 36 can be connected to the contact sensor 32 not only by the contact sensor connection KS but also by a torque sensor device MS with a sensor device 40 which serves to directly measure the operational torque MA occurring at the driveshaft 12. The measurement can be carried out, for example, based on the detection of changes in a magnetic field which is formed by a magnetic region 42 of the driveshaft 12.

Alternatively, the operational torque MA can also be determined by a calculation model. To this end, sensor means 44 is provided at the motor 6 for determining a motor current CM occurring at the motor 6, a motor speed DM, and a change in motor speed dDM. The data determined by the sensor means 44 are transmitted to the control device 36 recurrently by a drive sensor connection AS (see FIG. 1). This control device 36 determines a driving torque MM based on the measured motor current CM and a frictional torque MR based on the determined motor speed DM. In addition, a torque resulting from the inertia of the system is determined on the basis of the determined change in the motor speed dDM and a moment of inertia of the motor JM stored in the control device.

Using a respective transmission factor gr of the gear unit 10, the control device 36 calculates the instantaneous operational torque MA during operation by the following formula:

MA=gr*[MM−MR−JM*dDM].

After the contact area 24, according to FIG. 2c contacts, the constructional component 20, and the maximum tightening value MAmaxA has been determined by a control device 36 using one of the steps mentioned above, the motor 6 is then stopped in order to end the tightening process AV and the screwdriving process in its entirety.

In order to terminate the screwdriving process as exactly as possible when the maximum tightening value MAmaxA is reached, the speed D is further reduced steadily proceeding from an intermediate value Dzw already shortly before the maximum tightening value MAmaxA is reached, and the drive 4 is switched off. The time for switching off is preferably selected by means of an algorithm in such a way that the desired maximum tightening value MAmaxA is reached when the motor 6 comes to a stop.

Alternatively or in addition to this passive braking of the drive 4, an active braking can also be provided and carried out, for example, by reversing the rotational direction of the motor 6. An active braking of this kind can be provided, for example, by way of substitution in case the rise in the operational torque MA during the tightening process AV is too steep or too irregular, so that the maximum tightening value MAmaxA can be met exactly enough with the passive braking when the screwdriving process is concluded.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A method of controlling a drive (4) of an electrically operated screwdriving tool (2) during a screwdriving process, in which the drive (4) acts on a working tool holder (14) in which a screwdriving bit (16) is received for screwing a fastening element (16) having a contact area (24) in a constructional component (20), with the screwdriving bit (16) being displaceable up to a maximum screw-in value (Dmax) of a speed (D) and with an operational torque (MA) being generated between the screwdriving bit (16) and the fastening element (18), the method comprising the steps of:
detecting reaching of a predetermined triggering screw-in depth (sO) dependent on an operational torque curve up to a reference point (R); thereafter
reducing speed (D) from a maximum screw-in value (Dmax) in the course of a tightening process (AV); and
determining a maximum tightening value (MAmaxA) of an operational torque (MA) at which a screw-driving process is terminated and terminating the screwdriving process when the maximum tightening value (MAmaxA) of the operational torque (MA) has been reached.

2. A method according to claim 1, wherein the maximum tightening value (MAmaxA) is calculated depending on a maximum screw-in value (MAmaxE) of the operational torque (MA).

3. A method according to claim 1, wherein the reference point (R) is defined by a time point at which the triggering screw-in depth (s0) is reached, plus a predetermined time period (dt).

4. A method according to claim 3, wherein reduction in speed (D) has a continuous curve and is carried out after the reference point (R) is reached.

5. A method according to claim 1, wherein the triggering screw-in depth (s0) is detected with contact sensor (32).

6. A method according to claim 1, wherein the speed (D) is reduced to a predetermined intermediate value (Dzw) during the tightening process (AV).

7. A method according to claim 1, wherein operation of the drive (4) is terminated when the drive is switched off.

8. A method according to claim 1, wherein operation of the drive (4) is terminated by braking the drive (4).

9. A hand-held screwdriving power tool, comprising a tool holder (14) for receiving a screwdriving bit (16) for screwing a fastening element (18) having a contact area (24) in a constructional component (20); a drive (4) for driving the tool holder (14); a contact sensor (32) for determining reaching of a predetermined triggering screw-in depth (30) that corresponds to an end of a screw-in process (EV) and a start of a tightening process (AV); and a control device (36) for controlling operation of the drive (4) and which in response to a control signal generated by the contact sensor (32) upon detection of reaching of the triggering screw-in depth (sO), reduces a drive speed (D) from a maximum screw-in value (Dmax) in the course of a tightening process and calculates a maximum tightening value (MAmaxA) of an operational torque (MA) at which a screwdriving process is terminated.

10. A hand-held screwdriving power tool according to claim 9, wherein the contact sensor (32) has a contact sleeve which encloses the tool holder (14) and which projects out over the contact area of the fastening element (18) in an initial position in a screw-in direction (R).

11. A hand-held screwdriving power tool according to claim 9, further comprising a sensor device (40) for determining the operational torque (MA) by detecting torque-dependent changes in a magnetic field formed by a magnetic area (42) of a driveshaft (12) and connected to the control device (36) for signaling the changes.

12. A hand-held screwdriving power tool according to claim 9, comprising sensor means (44) for determining a motor current (CM) occurring at the drive (4), a motor speed (DM), and a change in motor speed (dDM) and connected to the control device (36).
